(19) United States
(12) Patent Application Publication
(10) Pub. No.: US 2013/0185625 A1
(43) Pub. Date: Jul. 18, 2013

(54) SYSTEM AND METHOD FOR INTELLIGENTLY SIZING CONTENT FOR DISPLAY

(71) Applicants: Chip Meyers, Rancho Palos Verdes, CA (US); Stefan Kosel, Miami, FL (US); Matt Tessar, Boulder, CO (US)

(72) Inventors: Chip Meyers, Rancho Palos Verdes, CA (US); Stefan Kosel, Miami, FL (US); Matt Tessar, Boulder, CO (US)

(73) Assignee: SKINECTED, Venice, CA (US)

(21) Appl. No.: 13/352,815

(22) Filed: Jan. 18, 2012

(51) Int. Cl. G06F 17/00

(52) U.S. Cl. 715/234

(57) ABSTRACT

The present design deploys nonstandard graphic content to a user. The design determines, using a computing device, mandatory content on an existing page, determines existing page attributes from code associated with the existing page, and establishes dynamically created zones on a target page for the nonstandard graphic content based on the mandatory content and existing page attributes. The design further incorporates the nonstandard graphic content with the mandatory content on the existing page to form the target page and provides an indication to transmit the target page including the nonstandard graphic content to the user.

### BACKGROUND OF THE INVENTION

1. Field of the Invention

The present invention relates generally to sizing nonstandard content for display on a computing device, such as a personal computer, and more specifically to providing for the effective display of nonstandard content, such as advertising, in conjunction with a target page of content based on the attributes and elements of the nonstandard content in view of the available display space and attributes of the target page.

2. Description of the Related Art

Current internet web site activity entails a user visiting a website. The traditional web site can include zones, areas, or regions employing standards established by a standards board such as the IAB (Interactive Advertising Bureau). In a typical scenario, a web site developer can, for advertising purposes, provide an available region or zone of IAB standard space available on the target web page. The web site developer may provide one or more javascript tags for the region and may create an aesthetically pleasing web page including the web page with essentially a space or spaces reserved for advertising.

Each advertisement is not necessarily hard coded into the page, nor provided on the same server as the rest of the target page content, but instead may ultimately be provided by a third party when the web site is ultimately rendered to the user. For example, depending on user preferences reflected by user cookies or other factors, a user who has visited a number of music sites may at a subsequent site be presented with music advertising content by a third party advertiser. The music seller may pay the third party advertiser who may in turn compensate the web site owner for the use of the space on the web site. Such an arrangement is potentially beneficial for all parties—the user, the web site owner, the advertiser, and the company, i.e. the music seller.

The problem arises when an advertiser or company wishes to provide nonstandard content, or nonstandard ad units (NSAU), on a web site originally set up to display standard content. Nonstandard content may include static content having nonstandard sizing, nonstandard video or other multimedia presentations, and so forth, and may include virtually any graphical representation not satisfying IAB standards. In fact, many developers and advertisers are currently producing content that exceeds certain IAB standards. In this nonstandard content situation, content is either not displayable on web sites employing standard IAB regions and javascript tags, or such content is partially or incompletely displayed. Either situation is unacceptable, as the nonstandard content simply does not reach the user in its intended form.

Another way such nonstandard content has been addressed is by web site developers going into the HTML or CSS code for the web site and altering the javascript tags associated with content on the page, or in other words rewriting HTML or CSS code to alter the target page to meet the nonstandard page requirements. This presents problems in that only advertisers able to provide the nonstandard content through manually added publisher tags can use the target page, and any desire to revert to IAB standard zones or regions requires going back in and altering the javascript tags again. The result of recoding is a limited amount of advertising being available to the user, in that perhaps one or two advertisers may employ or have available nonstandard content of the proper size and attributes available for the target page at any given time. Further, such recoding is expensive and time consuming and thus undesirable.

Attractive display of content is of particular importance. When nonstandard content is provided, the colors in the nonstandard content may either be too prominent and distract from the rest of the web site, or may be too subtle and may not garner appreciable attention. Both of these conditions are inadequate in the current Internet environment.

Various attempts have been made to address these issues, but in large regard these attempts have had varying success. The difficulty is properly providing and positioning nonstandard content dynamically, without the manual process of adding custom code by the publisher, in a form that is attractive and complete but not overly distracting, without requiring redesign of the target web page or worse, repeated redesign of the target web page depending on the advertising employed. Such content should be provided without requiring complete web site redesign or establishing permanent nonstandard content zones on a target site.

While the present discussion has focused on web pages generally, it is to be understood that any device or software that displays a set of nonstandard visual content may have sizing issues needing to be addressed. Particularly with recent smartphone innovations, the ability to accurately and pleasantly conveying content to a user has never been of more interest.

It would therefore be beneficial to provide a design that accurately and attractively sizes and presents nonstandard content irrespective of the device on which the content is conveyed. Such content should be attractively and completely presented, with particular focus on aesthetically pleasing coloring and size.

### BRIEF DESCRIPTION OF THE DRAWINGS

For a more complete understanding of the present disclosure, reference is now made to the following figures, wherein like reference numbers refer to similar items throughout the figures:

FIG. 1 illustrates the intake portion of the present design;

FIG. 2 is a flowchart of the initial intake process;

FIG. 3 shows the formats and positions of target web page elements and elements that may be nonstandard and provided using the present design;

FIG. 4 represents the deployment portion of the present design;

FIG. 5 shows process flow using SSPs, DSPs, and ad servers; and

FIG. 6 is a flowchart of deployment of a target web page including nonstandard graphical elements.

The exemplification set out herein illustrates particular embodiments, and such exemplification is not intended to be construed as limiting in any manner

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design provides a system for providing nonstandard content (including but not limited to graphics, videos and animations) to users, including an automated process of sizing and deploying such content. In general, when a web site is identified that is to be rendered with nonstandard graphics, the present system obtains all pertinent information from the target page, determines those elements of the target web page that are required, and sizes all other areas for nonstandard graphics, such as advertising, including left and right side graphics and top graphics. Once recast, the present design transmits the new target web page to the user. During the procedure, background colors may be assessed and set. The end result is a page including all requisite content plus nonstandard graphics that can subsequently be altered to include different graphics or the device can cause the web site to revert to its original state.

The present design enables the creation of useful and visually pleasing nonstandard content, such as advertising, on a page such as a target web page. The present design initially detects the width of existing content on a target page, and adds incremental content, such as advertising, to the desired page by determining and utilizing the unused space on the page, such as on the left or right sides of the page or the top or bottom of the page. The present design can create multiple images for a single desired page based on a single nonstandard image or nonstandard multimedia piece of content. The present design can also determine an appropriate and appealing background color without user intervention.

The present design seeks to obtain information, such as HTML or CSS information, from an existing target web page, knowing the nonstandard content desired to be displayed. The present design determines an appropriate layout for all content on the target page including the nonstandard content, and provides the requisite javascript tags and content for full display of the nonstandard content and the target web site on the target web site. The result is basically “two trips” to the target web site; one for determining existing web site structure, followed by processing of target web site attributes for the nonstandard content, followed by a “return trip” to the target web site to deploy or provide the page including the nonstandard content. In this arrangement, the web site may at a later time be changed back to its original form or any other desired form without developer intervention. The entire procedure is automated and does not require oversight, approval, rewriting of code, or any significant publisher, user or developer intervention.

The present design may be implemented on a computing device, such as a server or series of servers. While certain functionality may be described with respect to a single device, it is to be understood that such functionality may be performed using multiple devices. Further, functionality shown on multiple devices may be implemented on a single device.

The present design will be discussed with reference to advertising, but it is to be understood that the functionality and processing disclosed herein is not so limiting. The current state of online advertising is known to those skilled in the art, and includes various components, such as ad servers, exchanges, and so forth, and bidding may occur for advertising. Cookies are exchanged between elements to facilitate providing appropriate advertising to specific users. Devices such as Demand Side Platforms (DSPs) and Supply Side Platforms (SSPs) and ad exchanges enable the buying and selling of digital media using real time bidding based on real time information obtained from users.

In normal operation, a user causes his browser to navigate to a web site. The publisher's server provides HTML code, including HTML tags indicating where content is located and formatting for the content. The HTML code may include ad tags, tags representing advertisement which can be obtained from advertising entities and typically change dynamically. The ad tag may point to a real time bidding (RTB) enabled SSP, and may include IAB dimensions, the advertiser's ID and site ID. The SSP typically auctions the advertisement space to one or more DSPs. In addition to a bid, DSPs typically also provide a redirect command, used when the DSP wins the auction. The user's browser then calls the DSP, the DSP provides the redirect, the user's browser calls the advertising entity's ad server, and the advertising entity provides the advertisement to the user's browser.

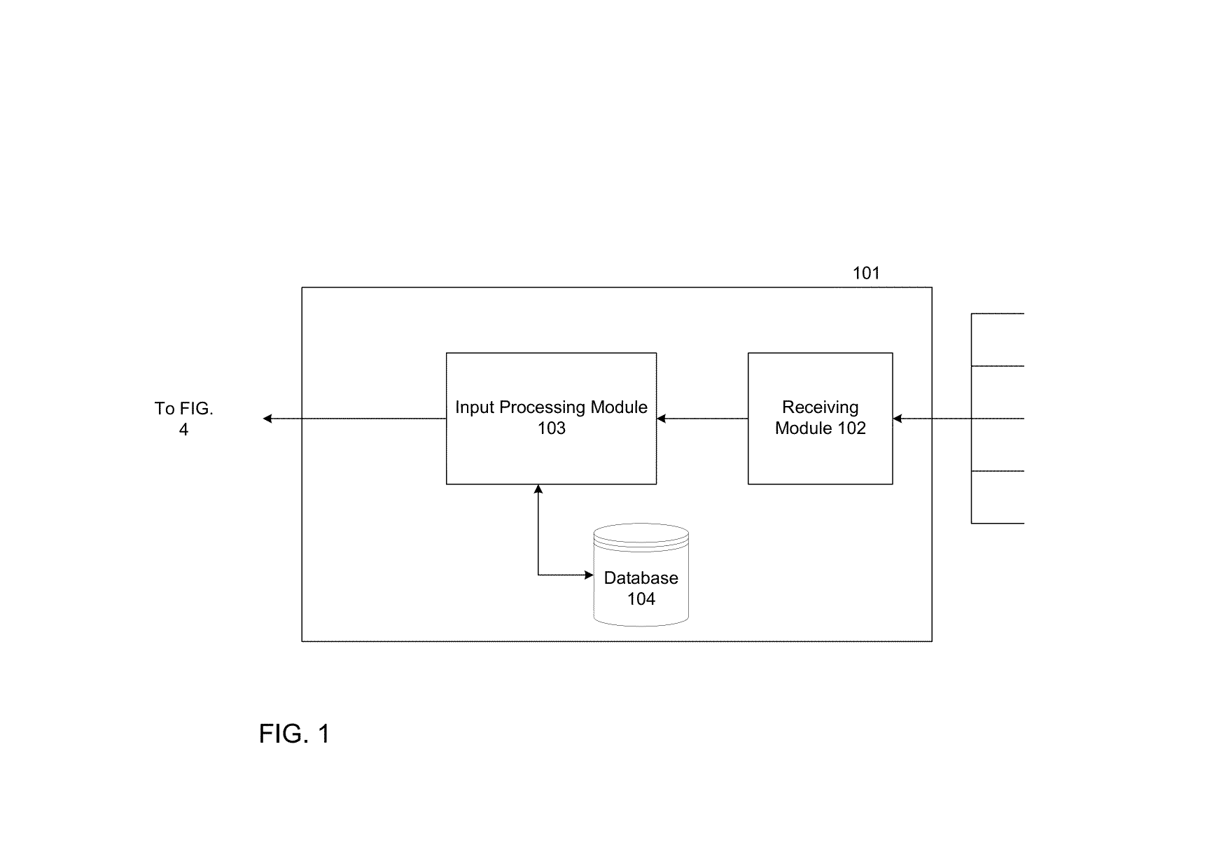

The current discussion takes into account this type of advertising processing, but may be employed in other types of content providing scenarios. FIG. 1 illustrates a general representation of the “intake” portion of the present design. In general, the system 101 is divided into two major functional components—an intake component and a dynamic allocation component. The intake component illustrated in FIG. 1 obtains necessary information and content from a web site owner and/or advertiser, and again may be implemented on a single computing device or multiple computing devices.

In general, the present design may be applicable to multiple campaigns, which typically entail either a content provider or an advertiser seeking to provide nonstandard content to existing or contemplated pages to be viewed by end users. A campaign may entail, for example, placing nonstandard content on 1200 web pages, replacing existing standard content on 250 pages with nonstandard content, placing nonstandard content or nonstandard content tags on all web pages associated with a particular URL, or any other operation that provides nonstandard content to web pages as desired by an entity. Standard content may be provided with nonstandard content as desired and as provided within the campaign. A campaign may include a “rotation,” which indicates that certain advertisements or categories of content, such as nonstandard display content, may be displayed on a number of web sites for a period of time.

From FIG. 1, system 101 includes a receiving module 102 configured to receive information from external sources (not shown). Receiving may be receipt from web sources, files loaded into system 101, files determined by a user using the system 101 and conveyed to the receiving module, or any other means conventional in the art. Materials or information received may be web sites, graphics or multimedia content, and/or requests for providing nonstandard content to an existing target web page, set of web pages, or URL. Once received, input processing module 103 may process the information received, including determining country restrictions or requirements for the target web page or pages. The input processing module 103 may utilize stored information, where database 104 in FIG. 1 represents any form of storage available, and such storage may be external to system 101. Input processing module 103 may determine rotation requirements, e.g. a web page displayed in country X will include web pages 27 and 28 only, and advertisements G, H, I and J will be offered. Such information may be provided by the entity requesting the campaign or may be determined based on country restrictions and/or information. For example, an advertisement for Icelandic arts and crafts in the Icelandic language may not be desired for a Brazilian URL.

Input processing module 103 may also provide for keyword association, wherein keywords are used to map URLs into categories. Keywords may include words such as “android” “tablet” and “laptop,” which may be mapped into categories such as “Phones” “Mobile” and “Computer,” respectively. Categories are used to match web sites to campaigns. Thus for a web site entitled “androidjunkies.com,” such a site would be categorized as being in the “Phones” category, and “Phone” advertising may be associated with the URL. Keywords may also be associated with URLs but not in the name of the URL.

Subsequent to employing keywords to map URLs into categories, the input processing module 103 classifies URLs entered via receiving module 102. URLs classified are then mapped into rotations by the processing module 103. For example, if an advertisement for mobile phones is to be deployed in a rotation of advertisements, a URL classified as “Mobile” may receive such an advertisement or set of content. A default category may be provided that the input processing module 103 employs for any uncategorized URL. If a URL includes multiple categories, the processing module combines all sets of nonstandard content.

The system then matches content to URLs based on rules and associations provided for the campaign and determined for the specific URL and specific content. The net result is an advertisement or set of nonstandard content to be provided with a target web page or web pages in a URL.

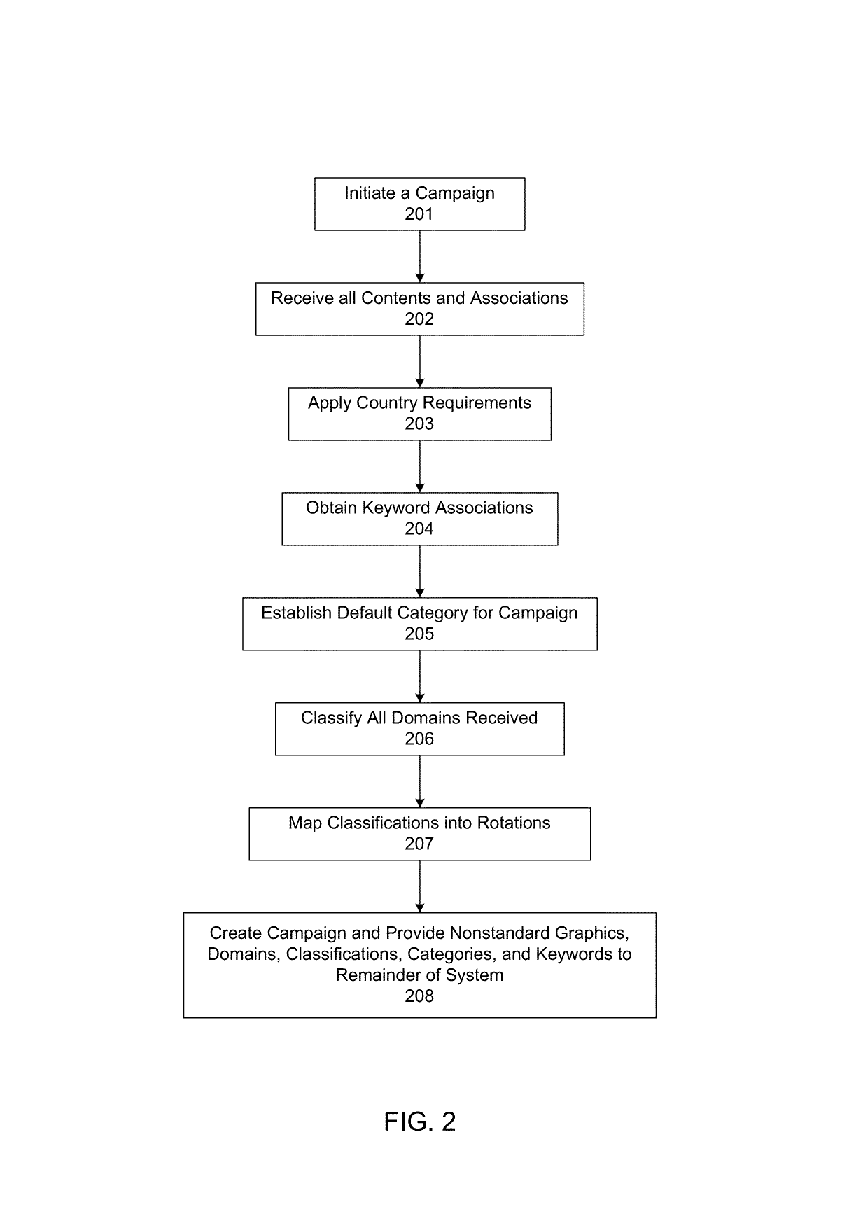

FIG. 2 shows this initial process. Element 201 initiates a campaign, namely providing associations between sets of content, potentially including nonstandard content, and sets of URLs and/or target sites. Element 202 receives and determines all content and associations, and element 203 applies country requirements. Element 204 determines keyword associations, wherein keywords map URLs into categories. Element 205 establishes a default category for the campaign, while element 206 classifies all URLs based on the categories available. The system 101 takes the classifications in element 207 and maps the classifications into rotations. Point 208 creates the campaign and provides content, including nonstandard content, URLs, classifications, categories and keywords to the remainder of the system 101.

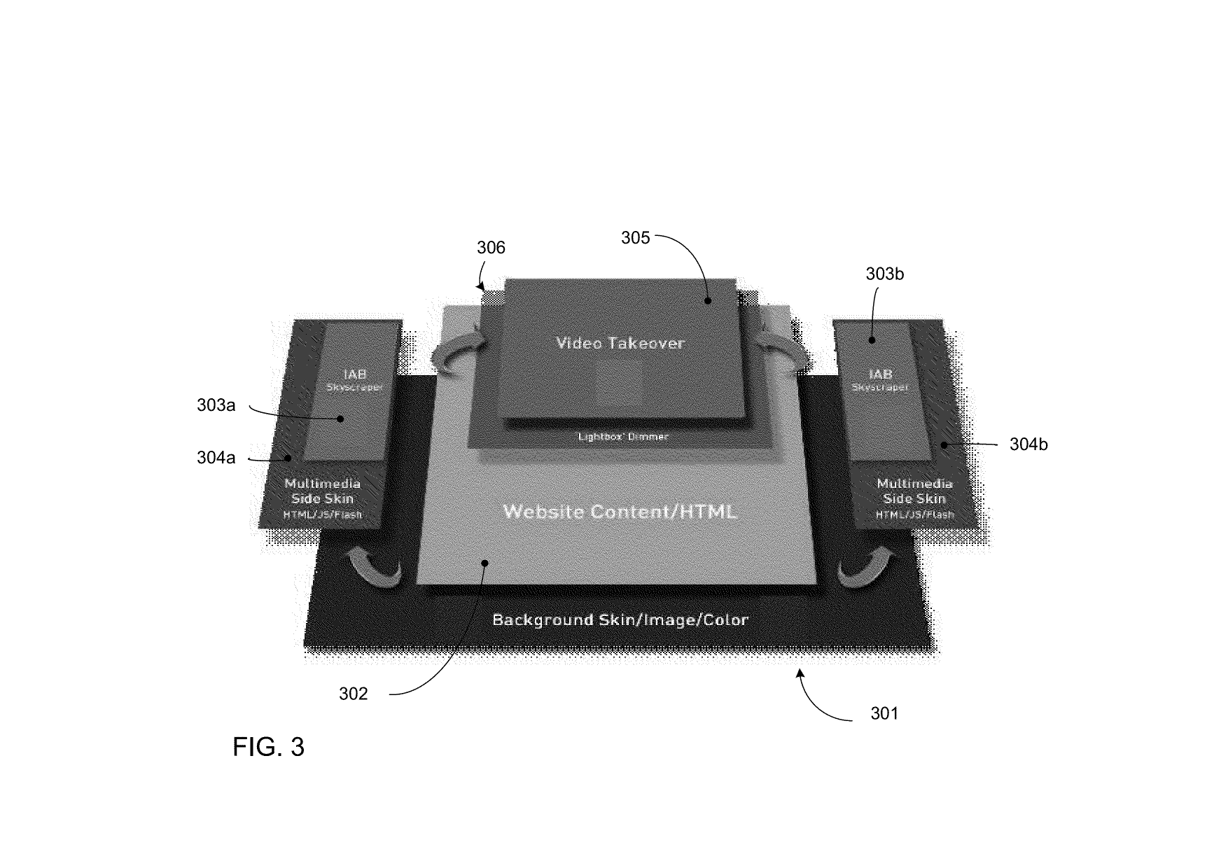

FIG. 3 illustrates the various formats and general positions for nonstandard content in a target page. From FIG. 3, a background 301 may be provided, with web site content 302 provided over the background 301. The IAB mandates dimensions for a “skyscraper” 303, with two such skyscrapers 303a and 303b illustrated. Beneath each skyscraper 303a and 303b is a multimedia side skin 304a and 304b, each of which may include HTML, javascript, Adobe Flash elements, or other content, wither nonstandard or standard. A video takeover 305 may be provided that essentially “takes over” the screen, including a “lightbox” dimmer 306 that enables clear viewing of the video takeover 305. All formats (background, side elements, video takeover) can be used alone or in combination with the other formats. Also, in place of or in addition to a video takeover, a top graphic may be provided, standard or nonstandard.

Under normal circumstances, i.e. for providing standard IAB content, for each existing IAB skyscraper creative element that is to be applied to at least one target site, the input processing module 103 reads the URL (Uniform Resource Locator, known to be a character string representing a reference to an internet resource (web page, file, etc.)) for the iFrame (inline frame, used to embed another document in the HTML of the page) that contains the existing IAB skyscraper creative element. The input processing module 103 writes out the javascript tag of the value for the SKYSCRAPER_IFRAME variable along with other required values related to the IAB skyscraper creative element (position, etc.). The input processing module 103 then adds the javascript tag with the URL for the IAB skyscraper creative element to a server or other device associated with the advertising entity. The advertising entity may then provide the content mandated by the javascript tags and the advertising entity may then deploy the javascript tag through a server, such as an advertising server, to a publisher, where the publisher publishes the web site to the user. When the user visits the web page, she receives the target page including the IAB creative element or elements, and javascript in operation displays the IAB creative element on the appropriate position on the user's screen. This represents the automated process of deploying standard content to the user.

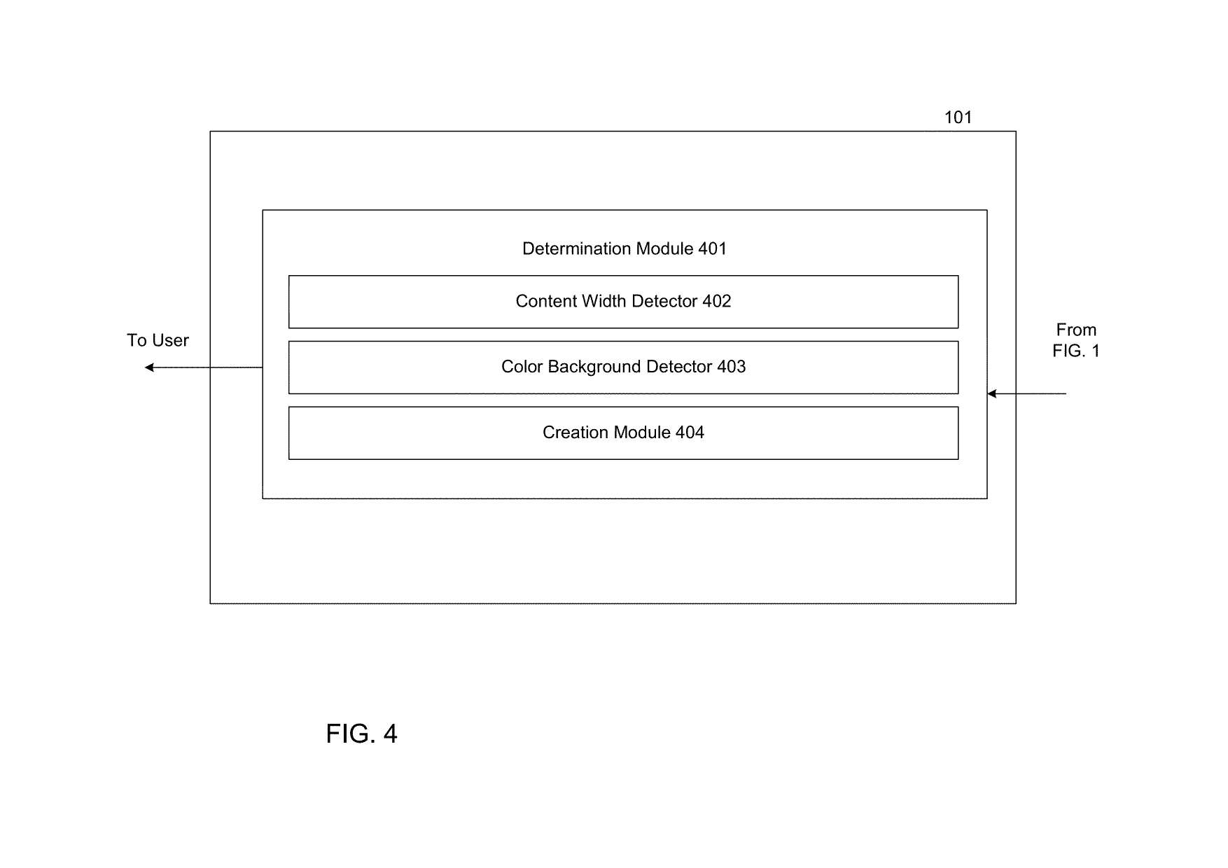

FIG. 4 illustrates the deployment components of the system 101, where the system seeks to deploy nonstandard creative elements to the user. In general, determination module 401 creates nonstandard zones in target pages where existing standard zones are employed or where such nonstandard components logically fit. The determination module 401 then dynamically creates/provides for nonstandard zones or regions by modifying the end user's document object model (DOM). Determination module 401 includes content width detector 402 and color background detector 403. Content width detector 402 sets a default width, such as 1000 pixels. The content width detector 402 script is configured to detect the width of the selected URL. The content width detector 402 iteratively assesses all divs (HTML div tag, used to define a division in an HTML document) in the body of the HTML of the window. The content width detector determines the width of each div and stores the maximum. If the divs did not have a width specified, the width is set to the default value. The content width detector then employs the width obtained. In this manner, the width of various elements on a page may be detected and standardized such that content may be inserted or altered while maintaining a desired look and feel of a site or target page.

The present design and the content width detector 402 use the extra space on the sides of the page content to display nonstandard graphics. The space visible to the end user depends on the end user's screen resolution. The actual screen resolution minus page content size defines a safe area, the safe area representing space safely viewable by the end user. Standard web site content is typically on the order of 1000 pixels currently, while screen resolutions can vary and may include, for example, 1280 pixels of viewable space or higher, and in most instances resolutions of 1280×768 may be required. The 280 pixel edges of the safe area may be employed to add creative elements, while the entire safe area will still include all essential copy. For higher resolutions, additional area may be available, but such area can be used for nonessential or secondary imagery to enhance the user experience, but may not be available to all users. Thus content width detector determines the space available for the desired content based on known resolutions.

Color background detector 403 obtains the creative element and loads the file, in an appropriate format such as png, gif, or jpg, into a php library (not shown). A php library is known in the art to be a preprocessing library for HTML pages. The color background detector 403 obtains the color for a certain number of pixels proximate the left side of the creative element, such as the colors in a line a certain number of pixels from the left edge of the creative element. The colors obtained are stored by the color background detector 403 in an array. The color background detector 403 may then obtain pixels proximate the right side of the creative image, such as the colors in a line a certain number of pixels from the right edge of the creative element, and this line of colors added to the array. Left and right may be processed in any order, and the number of pixels from the edge may vary, and more than one line may be sampled and added to the array. The color background detector then samples the array to determine the dominant color from the color array and uses this color as the background color for the creative element.

Color background detector may use the color array to collect all colors for selected pixels and determine a single, uniform background color for the graphic based on all colors in the array. Alternately, background colors may be determined for each graphic, i.e. one graphic sampled and the background color for that graphic determined, and another graphic sampled and background color determined for that graphic. Such an implementation can be useful if multiple background colors may be employed.

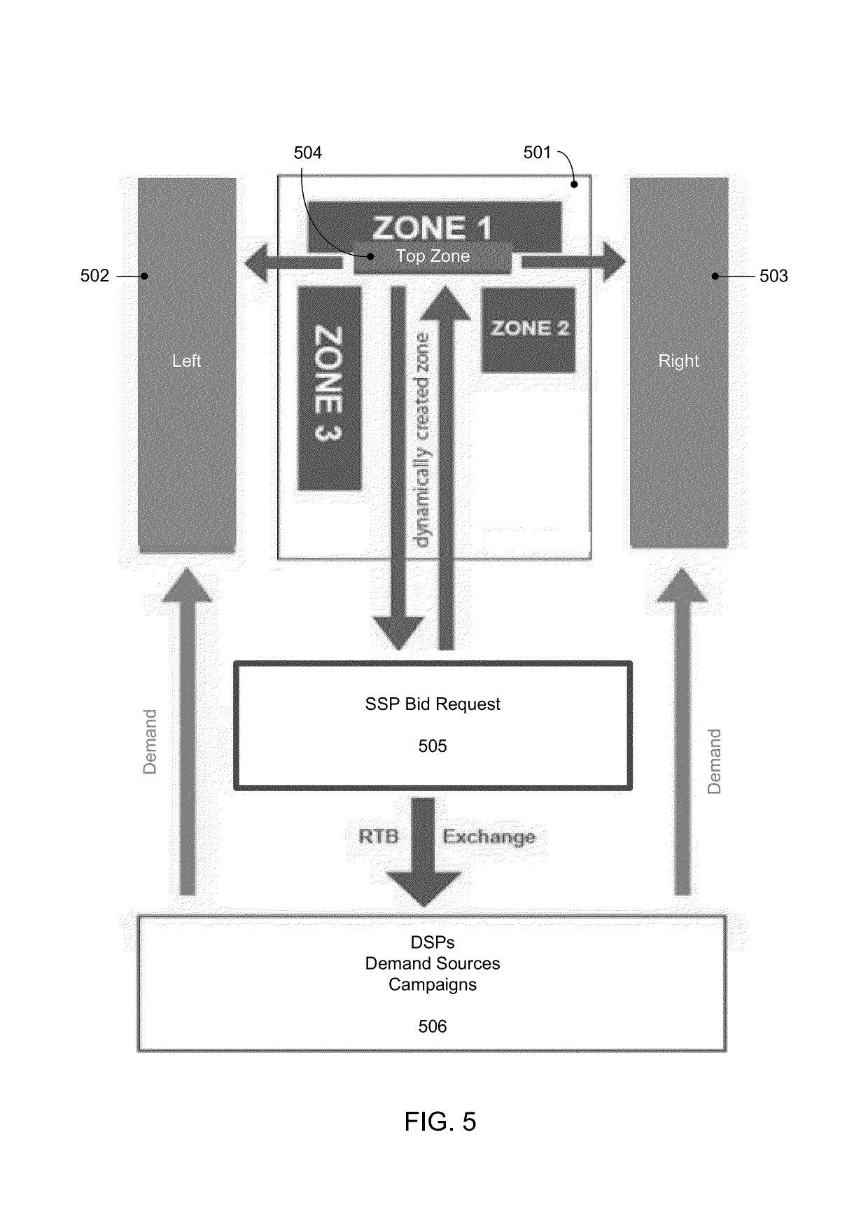

Size and content processing occurs in the context of the operations illustrated in FIG. 5. FIG. 5 generally reflects the SSP/DSP/ad server scenario described above. From FIG. 5, the publisher may have provided a target page having various existing zones of content, shown as zones 1, 2, and 3 in target page 501. Additional content may be provided based on the available free space determined by content width detector 402, shown as content zones 502 and 503. A further IAB standard content zone 504 may have been provided by the site publisher. Point 505 represents an SSP bid request. Point 506 represents DSPs bidding on the cooki using the real time bidding exchange. When a bid is accepted, and the user requests loading of a page that points to a nonstandard element, the user's browser is directed to the nonstandard content and the web site. At this point, content processing using creation module 404 occurs.

Typical creative content provided may include a left graphic that may be displayed in left content zone 502, a right graphic that may be displayed in right content zone 503, and a central graphic or video or multimedia graphic in the center of the target page or at or near IAB standard content zone 504. In the case of a left graphic, creation module 404 creates a div element, namely “lwrap div”, which serves as the container for the left graphic. The creation module then sets a depth index to locate the left graphic on top of any existing background and sets the height of the left graphic to be at the top of the page and any overflow, i.e. excess graphic, to be hidden. The creation module 404 sets the left position of the lwrap to be at zero pixels (0px) from the left side of the display, and the right edge to 50 percent to cause the lwrap div to span the left half of the viewable page. The creation module 404 then appends the lwrap div to the body of the HTML page.

The creation module 404 then creates the left skyscraper div, which will contain the left side HTML content. The creation module 404 sets the width of the left skyscraper div to the specified width of the left side HTML content, sets height to 100 percent, and sets the left skyscraper div to an absolute position, with visibility set to “visible.” The creation module 404 sets the background color to the color determined by color background detector 403. The creation module then sets the right position of the left skyscraper div to zero to position the div, and sets some left padding to spread the background color to the left. Some number of pixels may be employed as padding, such as 1000 pixels to the left, but other values may be employed. The creation module 404 then sets the inner HTML for the left div content to the inner HTML for the left side of the graphic. Creation module 404 then appends the left skyscraper div to the lwrap div and adds the result to the target page.

The creation module 404 then provides for the right side graphic. Creation module 404 creates a div element, namely “rwrap div”, which serves as the container for the right graphic. The creation module then sets the depth index to locate the right graphic on top of any existing background and sets the height of the right graphic to be at the top of the page and any graphic overflow to be hidden. The creation module 404 sets the right position of the rwrap to be at zero pixels (0px), and the left edge to 50 percent to cause the rwrap div to span the right half of the viewable page. The creation module 404 then appends the rwrap div to the body of the HTML page.

The creation module 404 then creates the right skyscraper div to contain the right side HTML content. The creation module 404 sets the width of the right skyscraper div to the specified width of the right side HTML content, and sets the right skyscraper div to 100 percent height and sets the right skyscraper div to an absolute position, with visibility set to “visible.” The creation module 404 then sets the background color to the color determined by color background detector 403. The creation module 404 sets the left position of the right skyscraper div to zero to position the div, and provides some right padding to spread the background color to the right. Some number of pixels may be employed as padding, such as 1000 pixels to the right, but other values may be employed. The creation module 404 then sets the inner HTML for the right side DIV content to the inner HTML for the right side of the graphic. Creation module 404 then appends the right skyscraper div to the rwrap div and adds the result to the target page.

Similarly, creation module 404 may add a top section to the target page. The top graphic may be any type of graphic, including multimedia, in which case the following may apply to positioning of the lightbox dimmer or the multimedia graphic. Creation module 404 creates a twrap div, which serves as the container for the top graphic. The creation module 404 then sets the depth index to locate the top graphic above any existing background, i.e. to be viewable such that the background is not viewable. Creation module 404 sets the top of the top graphic to a zero point (0px), the left of the top graphic to be zero (0px) the width to be 100 percent of available width, and the height to the specified height of the top section. The creation module 404 sets any graphic overflow to be hidden and background color to the background color determined by color background detector 403. The creation module 404 then appends twrap div to the body of the HTML page, before the first child element on the body of the target page.

The creation module 404 then creates the new top div to contain the top HTML content. The creation module 404 sets the width and height of the top div to the specified width and height of the top HTML content, and also sets the right margin to zero (0px) and the left margin to the negative value of the width of the top div divided by two. The creation module 404 then sets the background color for the top div to the background color determined by color background detector 403 and sets the left position of the top div to 50 percent, i.e. the midpoint of the target page. The creation module 404 then sets the HTML of the top div to be the specified HTML for the top section, and appends the top div to the twrap div to add the top content to the page.

As may be appreciated, the ordering of processing by the creation module may be altered from the foregoing, such as when, for example, no left skyscraper is desired, or by processing the top div content before either side, or processing right before left.

The resultant target web page, including nonstandard graphics, is provided to the user. As an option, the system may retain previous attributes such that the target web page may revert to its initial form or some previous form. Alternately, the system may used the procedures disclosed herein to change the page to display IAB standard graphics, with simple adjustments to positions and attributes in accordance with the foregoing.

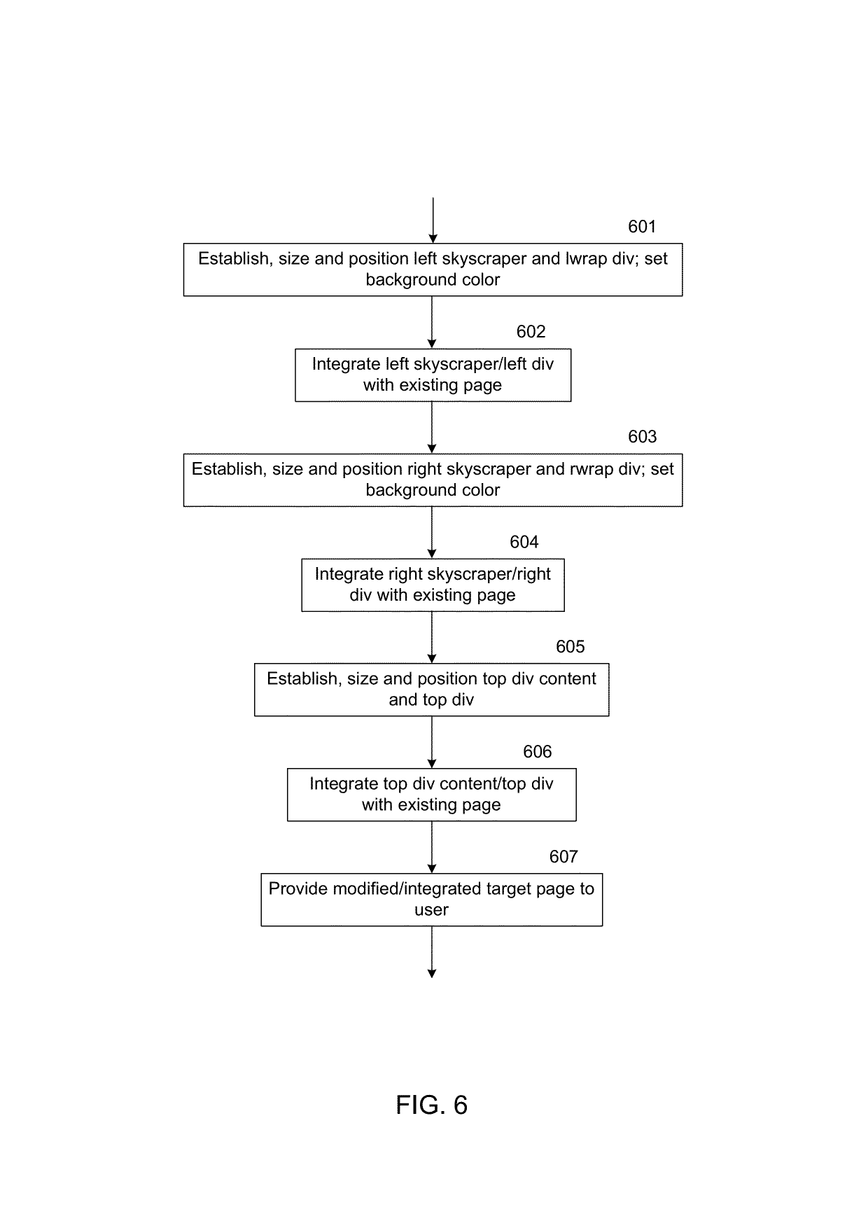

Operation of creation module 404 may be as shown in FIG. 6. Upon initially being contacted with a target web site that requires nonstandard graphics, the creation module 404 has the particulars of the web site or may obtain the particulars of the web site as discussed above if not available. The creation module 404 then establishes and sizes both the left skyscraper and left wrap div (lwrap div), and may set background color at point 601. The right skyscraper is integrated into or combined into the target page at point 602. The creation module establishes and sizes the right skyscraper and right wrap div (rwrap div) at point 603, and may set background color. The right skyscraper is integrated into or combined into the target page, including the right skyscraper, at point 604. Once integrated, these skyscrapers are available with the required content for the target web site. Point 605 sets the top div content and top div, including any lightbox dimmer, sizing and positioning the top div appropriately, which again are nonstandard. Point 606 calls for adding the top div to the page. At point 607, the complete page, including nonstandard graphics, is provided to the user.

The present design may be implemented using a network or distributed system, including a single server or multiple servers, and functionality may be distributed over multiple components or may exist in a single component. Further, functionality described herein may operate in hardware, software, firmware, or any combination thereof and no description provided herein is intended to be limiting in this regard. The present design may be substantially or completely internet based, operating with one or more servers, such that the user can access a server to request information, such as reports, as well as surveys, campaigns, resources, and other information. Users may modify the systems database contents from a platform providing, for example, Internet browsing capabilities.

While primarily described herein with respect to a knowledge management system, the invention and disclosure herein are not intended to be so limited. While certain examples are provided herein, these examples are meant to be illustrative and also not limiting as to the functionality of the present system. For example, while certain functions are suggested to be performed by a single individual, multiple persons may perform those functions. Other examples and implementations are possible and this document should not be limited by the examples presented. Other examples of knowledge resource allocation may be realized using the current design.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for deploying nonstandard graphic content to a user, comprising:
determining, using a computing device, mandatory content on an existing page;
determining existing page attributes from code associated with the existing page;
establishing dynamically created zones on a target page for the nonstandard graphic content based on the mandatory content and existing page attributes;
incorporating the nonstandard graphic content with the mandatory content on the existing page to form the target page; and
providing an indication to transmit the target page including the nonstandard graphic content to the user.

2. The method of claim 1, further comprising determining a background color for the target page based on the nonstandard graphic content.

3. The method of claim 1, wherein the nonstandard graphic content comprises at least one from a group consisting of:
left side content;
right side content;
top content; and
overlay content.

4. The method of claim 1, wherein establishing dynamically created zones comprises sizing at least one zone for nonstandard content on a side of the target page such that both the nonstandard content and the mandatory content fit on the target page.

5. The method of claim 1, wherein the computing device is configured to store attributes of the existing page for potential use subsequent to incorporating the nonstandard graphic content with the mandatory content on the existing page to form the target page.

6. The method of claim 2, wherein determining the background color comprises assessing a portion of the nonstandard graphic content and establishing the background color based on attributes of the portion of the nonstandard graphic content.

7. A computing device configured to provide nonstandard graphic content to a user in a target page, comprising:
means for determining mandatory content on an existing page;
means for determining existing page attributes from code associated with the existing page;
means for establishing dynamically created zones on the target page for the nonstandard graphic content based on the mandatory content and existing page attributes;
means for incorporating the nonstandard graphic content with the mandatory content on the existing page to form the target page; and
means for providing an indication to transmit the target page including the nonstandard graphic content to the user.

8. The apparatus of claim 7, further comprising means for determining a background color for the target page based on the nonstandard graphic content.

9. The apparatus of claim 7, wherein the nonstandard graphic content comprises at least one from a group consisting of:
left side content;
right side content;
top content; and
overlay content.

10. The apparatus of claim 7, wherein the means for establishing dynamically created zones comprises means for sizing at least one zone for nonstandard content on a side of the target page such that both the nonstandard content and the mandatory content fit on the target page.

11. The apparatus of claim 7, wherein the computing device is configured to store attributes of the existing page for potential future use.

12. The apparatus of claim 8, wherein the means for determining the background color comprises means for assessing a portion of the nonstandard graphic content and establishing the background color based on attributes of the portion of the nonstandard graphic content.

13. A computing device configured to provide nonstandard graphic content to a user in a target page, comprising:
a receiving module configured to receive an existing page and the nonstandard graphic content; and
a determination module configured to:
determine mandatory content on the existing page;
determine existing page attributes from code associated with the existing page;
establish dynamically created zones on the target page for the nonstandard graphic content based on the mandatory content and existing page attributes;
incorporate the nonstandard graphic content with the mandatory content on the existing page to form the target page; and
provide an indication to transmit the target page including the nonstandard graphic content to the user.

14. The computing device of claim 13, wherein the determination module is further configured to determine a background color for the target page based on the nonstandard graphic content.

15. The computing device of claim 13, wherein the nonstandard graphic content comprises at least one from a group consisting of:
left side content;
right side content;
top content; and
overlay content.

16. The computing device of claim 13, wherein the means for establishing dynamically created zones comprises means for sizing at least one zone for nonstandard content on a side of the target page such that both the nonstandard content and the mandatory content fit on the target page.

17. The computing device of claim 13, wherein the computing device is configured to store attributes of the existing page for potential future use.

18. The computing device of claim 14, wherein determining the background color comprises assessing a portion of the nonstandard graphic content and establishing the background color based on attributes of the portion of the nonstandard graphic content.
